(19) United States
(12) Patent Application Publication
(10) Pub. No.: US 2010/0061596 A1
(43) Pub. Date: Mar. 11, 2010

(54) Video-Based Breathing Monitoring Without Fiducial Tracking

(75) Inventors: Hassan Mostafavi, Los Altos, CA (US); Sergey Povzner, Burlingame, CA (US)

Correspondence Address: Vista IP Law Group (Varian), 1885 Lundy Ave, Suite 108, San Jose, CA, 95131, US

(73) Assignee: VARIAN MEDICAL SYSTEMS TECHNOLOGIES, INC., Palo Alto, CA (US)

(21) Appl. No.: 12/205,431

(22) Filed: Sep. 5, 2008

(51) Int. Cl. G06K 9/00; G06K 9/64

(52) U.S. Cl. 382/107; 382/209

(57) ABSTRACT

A method of determining a similarity with a portion of a physiological motion, includes obtaining a first image of an object, obtaining a second image of the object, determining a level of similarity between the first and second images, and correlating the determined level of similarity between the first and second images with a portion of the physiological motion. A computer product having a set of instructions, an execution of which causes a method of determining a similarity with a portion of a physiological motion to be performed, the method includes obtaining a first image of an object, obtaining a second image of the object, determining a level of similarity between the first and second images, and correlating the determined level of similarity between the first and second images with a portion of the physiological motion.

### RELATED APPLICATION DATA

This application is related to U.S. patent application Ser. No. ______, entitled “Systems and methods for determining a state of a patient,” having Attorney Docket No. VM 08-030US, filed concurrently herewith.

### FIELD

The present application relates to medical methods and systems, and more particularly, to methods and systems for monitoring activity of a patient, such as a breathing activity of an infant.

### BACKGROUND

A serious concern for parents of a newborn is the possibility of death by Sudden Infant Death Syndrome (SIDS). SIDS is commonly known as the sudden death of an infant under one year of age which remains unexplained after a thorough case investigation, including performance of a complete autopsy, examination of the death scene, and review of the clinical history. A SIDS death occurs quickly and is often associated with sleep, with no signs of suffering.

Although exact causes of SIDS are still unknown, mounting evidence suggests that some SIDS babies are born with brain abnormalities that make them vulnerable to sudden death during infancy. Studies of SIDS victims reveal that some SIDS infants have abnormalities in the “arcuate nucleus,” a portion of the brain that is likely to be involved in controlling breathing during sleep. However, scientists believe that the abnormalities that are present at birth may not be sufficient to cause death. Other factors, such as lack of oxygen and excessive carbon dioxide intake, may also contribute to the occurrence of SIDS. During sleep, a baby can experience a lack of oxygen and excessive carbon dioxide levels when they re-inhale the exhaled air. Normally, an infant can sense such inadequate air intake, and his breathing movement can change accordingly to compensate for the insufficient oxygen and excess carbon dioxide. As such, certain types of irregularity in an infant's breathing activity can be an indicator of SIDS or the likelihood of SIDS.

Therefore, monitoring of an infant's breathing activity for breathing irregularities could help prevent or detect the possibility of SIDS. One approach to monitor the breathing activity is to attach to the body of the infant a battery-powered electronic device that can mechanically detect the breathing movement. Although such device can monitor the infant's breathing directly, the battery can render the device large and heavy, which encumbers the tiny infant. Additionally, difficulty of attachment can be expected under this approach.

Another approach to monitor an infant's breathing activity is to install a pressure sensitive pad underneath the mattress where the infant is sleeping. The pad monitors the baby's breathing activity by measuring body movement. However, because the pad is unable to directly monitor the breathing movement, accuracy of the generated breathing data can be affected.

In another approach, a marker block with a plurality of markers is coupled to the infant's chest. By continuously tracking the positions of the markers, an infant's breathing movement can then be monitored during sleep.

### SUMMARY

In accordance with some embodiments, a method of determining a similarity with a portion of a physiological motion, includes obtaining a first image of an object, obtaining a second image of the object, determining a level of similarity between the first and second images, and correlating the determined level of similarity between the first and second images with a portion of the physiological motion.

In accordance with other embodiments, a computer product having a set of instructions, an execution of which causes a method of determining a similarity with a portion of a physiological motion to be performed, the method includes obtaining a first image of an object, obtaining a second image of the object, determining a level of similarity between the first and second images, and correlating the determined level of similarity between the first and second images with a portion of the physiological motion.

In accordance with other embodiments, a system for determining a similarity with a portion of a physiological motion includes means for obtaining a first image of an object and a second image of the object, means for determining a level of similarity between the first and second images, and means for correlating the determined level of similarity between the first and second images with a portion of the physiological motion.

Other and further aspects and features will be evident from reading the following detailed description of the embodiments, which are intended to illustrate, not limit, the invention.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only typical embodiments and are not therefore to be considered limiting of its scope.

FIG. 1 is a block diagram of a patient monitoring system in accordance with some embodiments;

FIG. 2 illustrates a method of using the system of FIG. 1 in accordance with some embodiments;

FIG. 3 illustrates an example of a template in accordance with some embodiments;

FIG. 4 illustrates examples of image frames in accordance with some embodiments;

FIG. 5 illustrates an example of a breathing curve aligned with an example of a correlation graph;

FIG. 6 illustrates another example of a correlation graph, a portion of which indicates non-motion of a subject;

FIG. 7 illustrates another example of a correlation graph that indicates non-periodic movement of a subject;

FIG. 8 illustrates another example of a correlation graph that indicates that a subject has shifted position;

FIG. 9 illustrates a method of using a time series of correlation values to detect conditions of a patient in accordance with some embodiments;

FIG. 10 illustrates a method of obtaining a template in accordance with some embodiments;

FIG. 11 illustrates another method of obtaining a template in accordance with other embodiments;

FIG. 12 illustrates that a level of correlation may be used to correlate with a certain amplitude of a physiological movement;

FIG. 13 illustrates another method of obtaining a template in accordance with other embodiments;

FIG. 14 illustrates that a level of correlation may be used to correlate with a phase of a physiological movement;

FIGS. 15A and 15B illustrate a technique for analyzing a time series of similarity values using Fourier Transform; and

FIG. 16 is a block diagram of a computer system architecture, with which embodiments described herein may be implemented.

### DESCRIPTION OF THE EMBODIMENTS

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated.

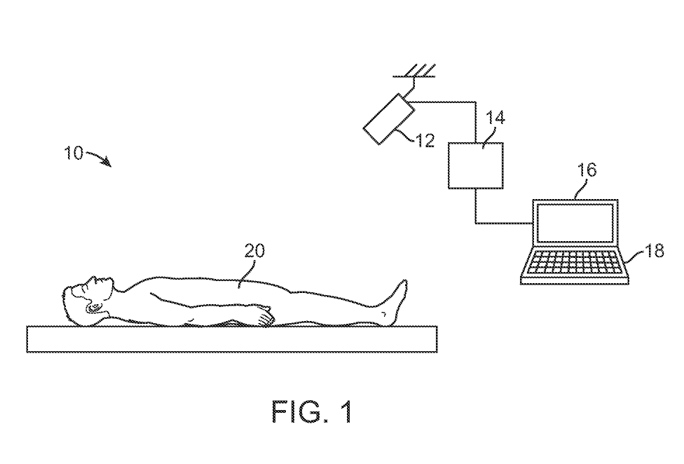

FIG. 1 illustrates a patient monitoring system 10 in accordance with some embodiments. The patient monitoring system 10 includes an optical device 12, and a processor 14. The optical device may be, for example, a charge-coupled device, such as a camera. In some embodiments, the camera may have an auto-focusing feature that allows the camera to automatically focus on a portion of an object that it is viewing. Alternatively, the optical device may be another type of imaging device that is capable of obtaining images of a patient. In the illustrated embodiments, the processor 14 is illustrated as a separate device from the optical device 12. In other embodiments, the processor 14 may be incorporated internally within the optical device 12, in which case, the processor 14 becomes a part of the optical device 12. In some embodiments, the system 10 may further includes a monitor 16 and a user interface 18, such as a keyboard and/or a mouse. In other embodiments, the user interface 18 may include one or more buttons that are integrated with the optical device 12. In such cases, the optical device 12 may also includes a screen, such as a LCD screen for displaying information.

During use, the optical device 12 is placed or mounted onto a structure, such as a table, a ceiling, or a patient support, and the optical device 12 is used to view a patient 20. The processor 14 receives images from the optical device 12, processes the images, and determine information regarding the patient 20. If the system 10 includes the monitor 16, images generated by the optical device 12 and information determined by the processor 14 may be displayed in the monitor 16.

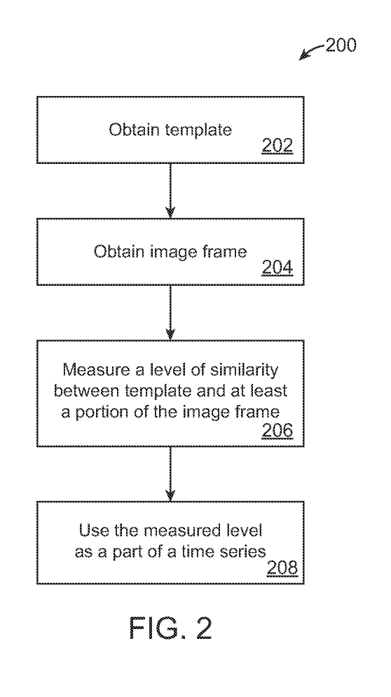

FIG. 2 illustrates a method 200 of using the system 10 in accordance with some embodiments. To set up for the method 200, the optical device 12 is mounted in a fixed position and orientation such that its field of view includes at least a portion of an object that moves due to the patient's breathing. For example, the optical device 12 can be pointed at the blanket covering a sleeping infant, or the clothing or skin of the patient 20 lying on a couch of an imaging or radiation treatment machine. Depending on the application, the coverage area of the moving object can range from a few to more than one thousand square centimeters. In some cases, if the optical device 12 is a camera, the focal length of the camera lens may be selected such that a desired coverage area is achieved for the camera distance that is convenient for a particular application and installation.

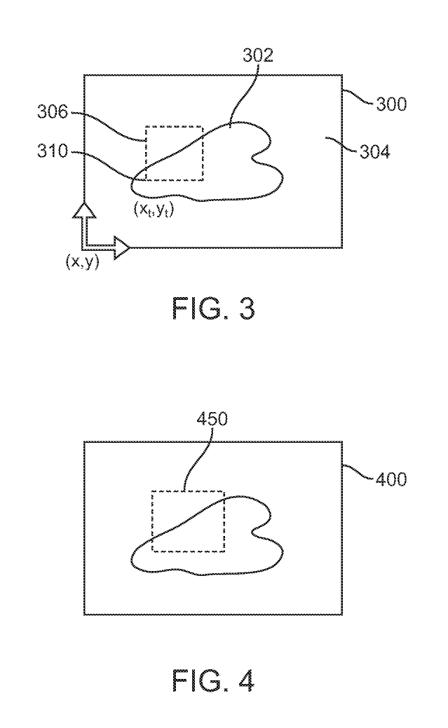

To begin method 200, an image template is obtained (step 202). In the illustrated embodiments, the optical device 12 is aimed at the object that moves with breathing to view at least a portion of such object, and an image frame is generated by the optical device 12. The object may be a part of the patient, or any object that is coupled with the patient, such as clothes (or portion thereof, blanket (or portion thereof, marker, etc. A portion of the image frame is then selected as the image template. In the illustrated embodiments, an area within the image frame over which there is some object movement is selected as the template. FIG. 3 illustrates an example of an image frame 300 that includes an image 302 of an object and an image 304 of a background. In the example, as the patient 20 undergoes breathing motion, the area 306 in the image frame 300 and other image frames in a sequence capture images of a part of the object that moves with breathing. Thus, the area 306 of the image frame 300 is selected as the image template in the example. In the illustrated embodiments, the position (Xₜ, Yₜ) 310 of the area 306 relative to the image frame 300 coordinate (X, Y) is stored for later use. Various techniques for obtaining the image template will be further described below. In some embodiments, an area in the image frame in which the patient's movement is the greatest may be selected for use as the image template. In other embodiments, instead of using an area in the image frame in which the patient's movement is the greatest, any area in the image frame in which there is some patient's movement (which may not be the greatest movement) may be used. Also, in other embodiments, instead of selecting a portion of the image frame as the image template, the entire image frame may be used as the image template. In some cases, if an image does not include any object that moves (e.g., an object that moves with breathing), the processor is configured to detect such condition, and generate an alert so that a user can adjust the camera, e.g., by aiming it towards a different direction.

Next, the optical device 12 is continued to view the object moving with breathing, and provides another image frame (input image) that contains an image of at least a portion of the patient 20 (step 204). FIG. 4 illustrates an example of another image frame 400. The image frame 400 contains an image of at least a part of the patient 20 that is captured when the patient 20 is breathing. Thus, the image frame 400 captures an image of the patient 20 at a certain phase of a respiratory cycle. The image frame 400 may be one of the images in a sequence that also contain the image frame (e.g., image frame 300 of FIG. 3) that is used to obtain the image template of step 202.

Next, a level of similarity between the image template 308 and a portion of the input image 400 is measured (step 206). In particular, the portion 450 of the input image 400 that is at the same relative position 310 (at which the image template 308 is obtained from the image frame 300) is used to compare with the image template 308. In other words, the measure of similarity is calculated between the template and a fixed sub-area of the input image 400 (i.e., the fixed sub-area of the image frame that is used to define the template). Various techniques may be used to measure the level of similarity between the image template 308 and the portion of the input image 400. In some embodiments, the processor 14 may perform a normalized cross correlation between the image template 308 and the portion of the input image 400.

Because the image template is obtained from an image frame that is generated when the patient 20 is at a certain position (e.g., a position that may correspond with a certain phase of a respiratory cycle), if the input image (e.g., input image 400a) is generated when the object moving with respiration is in the same position as that associated with the image template, the resulting level of correlation would be high. On the other hand, if the input image (e.g., input image 400b) is generated when the portion of the patient 20 is in a different position from that associated with the image template, the resulting level of correlation would be relatively low. It should be noted that the correlation determined by the processor may or may not be normalized. If normalized correlation is used, the value of the normalized correlation (correlation coefficient) is used to represent a level of similarity between the two images. In other embodiments, instead of cross-correlation, other similarity measures may be used, such as, mutual information, absolute difference, etc.

Returning to FIG. 2, after the level of similarity is determined, the determined level of similarity is then used as a part of a time series (step 208). The above steps 204-208 are then repeated. In particular, the processor 14 obtains additional image frames (step 204), and measures levels of similarities for respective additional image frames (step 206). The image frames may be images that are generated in a sequence. For example, the image frames may be images that are generated successively one after the other. Alternatively, the image frames may be every other image, or images spaced at other intervals (e.g., every 3rd image, every 4th image, etc.) that are in the sequence. The measured levels of similarities together form a time series that can be used by the processor 14 (step 208).

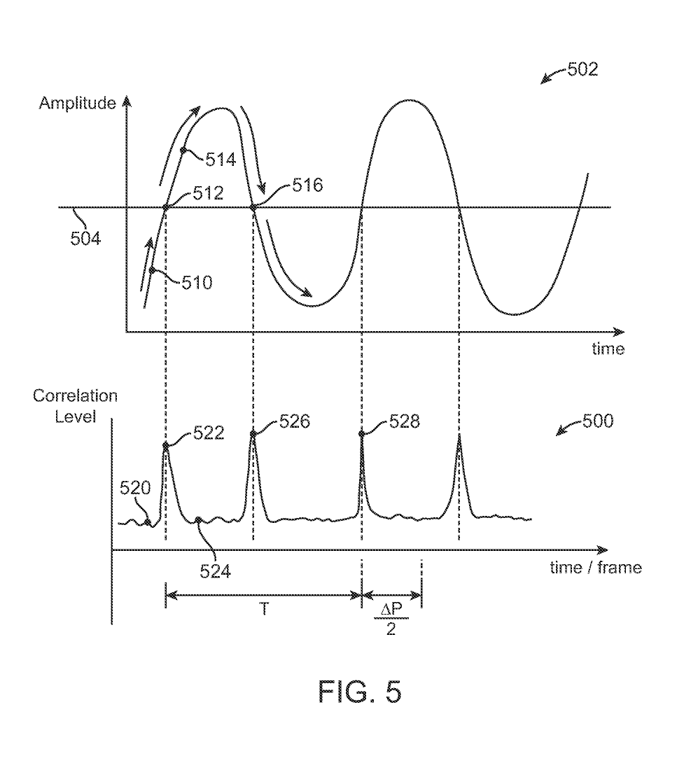

FIG. 5 illustrates an example of a time series 500 of similarity values that may be generated using the method 200. In the figure, the time series 500 is aligned with a breathing chart 502 to show the relationship between various points in the time series 500 and the points in the breathing chart 502. The time series 500 includes a plurality of points representing levels of correlation between the image template and respective input image frames that are determined in step 206 of the method 200. In the illustrated example, the time series 500 is constructed by connecting the data points to form a continuous graph. In other embodiments, the data points in the time series 500 need not be connected, and the graph of the time series 500 is presented as a series of points. The breathing chart 502 illustrates a breathing pattern of the patient 20, with the x-axis representing time, and the y-axis representing amplitudes of motion (e.g., motion of chest, motion of the patient's clothes, motion of a blanket covering the patient 20, etc.) associated with the breathing. A line 504 is shown in the chart 502, wherein the line 504 represents the amplitude at which the image template is generated. As the patient 20 inhales at point 510, the image frame captured by the optical device 12 will be different from the image template, and the level of similarity between the image template and the image frame corresponding to point 510 (point 520 in time series) will be low. At point 512, the image frame captured by the optical device 12 will be the same as the image template (because they are captured when the patient 20 is in the same position), and the level of similarity between the image template and the image frame corresponding to point 512 (point 522 in time series 500) will be high. As the patient 20 continues to inhale, his/her position moves away from the position that corresponds to line 504, and as a result, the level of similarity between the image frame at point 514 and the image template is relatively low (point 524 in time series 500). The patient 20 then exhales, and when the breathing pattern reaches point 516, the image frame captured by the optical device 12 will be again the same as the image template (because they are captured when the patient 20 is in the same position), and the level of similarity between the image template and the image frame corresponding to point 516 (point 526 in time series 500) will be high.

As illustrated in the figure, the peak values (e.g., points 522, 526) in the time series 500 correlate with certain parts of a physiological motion (e.g., the parts of the breathing motion having amplitude that corresponds with line 504). Thus, the time series 500 may be used to correlate with the physiological motion of the patient 20. Also, in the illustrated example, the processor 14 may determine the period T of the patient's breathing cycle by calculating the time spacing between every other peak (e.g., between peak 522 and peak 528).

In accordance with some embodiments, the time series of similarity values may be used to determine physiological information about the patient 20. For example, in some embodiments, the time series of the measured level of similarities is analyzed by the processor 14 in real time to determine if there is a lack of motion by the patient 20. The no-motion condition can result from the patient 20 having stopped breathing, or because of a position shift that has left no moving object inside the camera field of view. Lack of motion can be detected by detecting a plurality of correlation points in the time series that form a “flat-line” configuration. In some embodiments, this is achieved by calculating the variation of the signal over a sliding time window that trails the current image frame. The length of the window can be a fixed number of seconds, or it can be an adaptive window, for example, set to two breathing cycles and updated periodically according to the latest estimate of the breathing period. The threshold value of signal variation resulting in a no-motion alert is a multiplier of the noise level in the signal. The noise level is estimated automatically by a real-time signal smoothing method. For example, if the signal 99 percentile amplitude variation over the sliding time window does not exceed a multiplier of six standard deviations of the noise, then the no-motion output alert is generated.

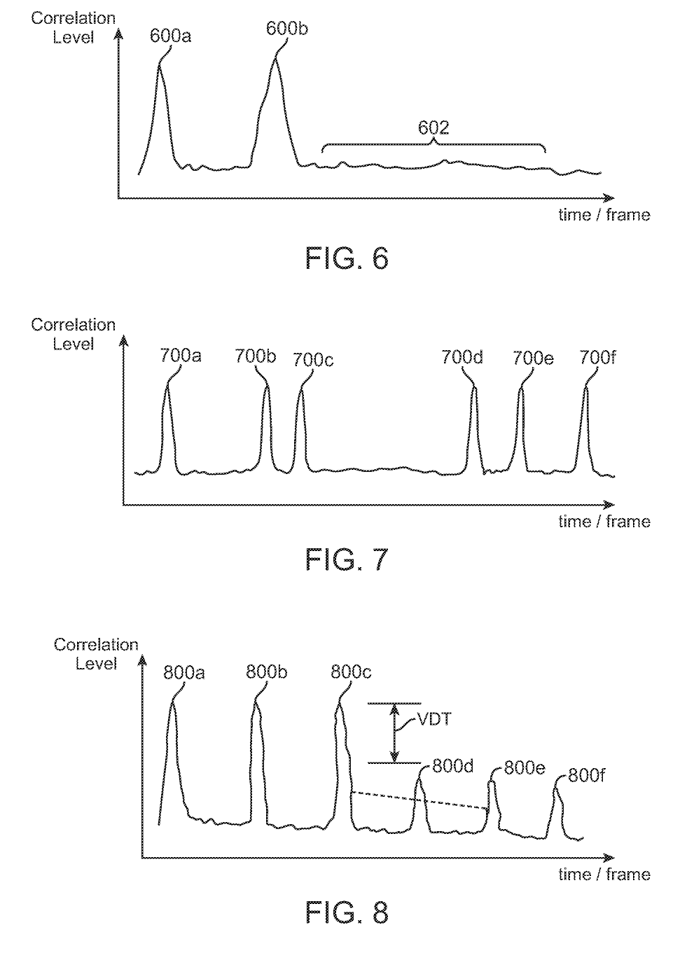

FIG. 6 illustrates an example of a time series of measured level of similarities having a pattern that may be indicative of a lack of motion by the patient 20. As discussed, the time series is obtained by determining a level of similarity between the image template and a portion of each input image in a sequence. The result is a series of points with values that represent levels of correlation/similarity between respective input images (i.e., the portion within the respective input images) and the image template. In the example, the series of correlation points are connected to highlight the pattern of the series. In the illustrated example, the processor 14 keeps track of the peaks 600 that represent high correlation between the image template and the input image portions. If the processor 14 determines that there is no peak for a prescribed duration (i.e., a flat-line condition) after the last detected peak, such as the portion 602 illustrated in the example of the time series, then the processor 14 determines that there is lack of motion by the patient 20. In some embodiments, if such condition is detected, the processor 14 may generate a warning signal, such as an audio and/or a visual signal, to alert that the patient 20 is not moving. In some embodiments, the prescribed duration may be expressed as a multiplier of a breathing period BP of the patient 20, such as 2BP, 3BP, etc. In other embodiments, the prescribed duration may be an actual time value that is between 5 seconds and 24 seconds. In further embodiments, the prescribed duration may be expressed in terms of breathing period, such as any value between 2 to 4 breathing periods. Also, in some embodiments, the condition that no peak is considered detected if the level of correlation is below a prescribed level. For example, in the case of a normalized correlation, the condition that no peak is considered detected if the level of normalized correlation is below 15%. Other threshold values may also be used in other embodiments. The prescribed duration and the correlation threshold may be inputted via the user interface 18 or may be set to fixed values that are known to work for a given application.

In some cases, the noise level used in automatic threshold setting for flat-line detection can be estimated by subtracting a smoothed portion of the signal from the original signal. The smoothed signal can be obtained by an Nth order polynomial fit to the signal over a sliding window that trails the current signal sample. For example, the fitting parameters can be N=3 and a window length of 1 second. Alternatively, an adaptive window length equal to 20% of the breathing period (which is estimated in real time) can be used. The polynomial value at the current sample time represents the smoothed version of the signal. The difference between this and the original signal is observed over the same time window as the one used for flat-line detection. The RMS value of the difference can be used as the noise platform for adaptive threshold setting in flat-line detection.

In other embodiments, the time series of the measured level of similarities is analyzed by the processor 14 in real time to determine if there is irregularity (or lack of periodicity) in the breathing pattern of the patient 20. FIG. 7 illustrates another example of a time series of measured level of similarities having a pattern that may be indicative of lack of periodicity in the breathing of the patient 20. In the illustrated example, the processor 14 keeps track of the peaks 700 that represent high correlation between the image template and the input image portions, and the time duration between each adjacent peaks 700. If the processor 14 determines that the time durations between adjacent peaks exhibit an irregular pattern, such as the example shown in FIG. 7, then the processor 14 determines that there is lack of periodicity in the patient's breathing. In some embodiments, if such condition is detected, the processor 14 may generate a warning signal, such as an audio and/or a visual signal, to alert that the patient 20 is not breathing regularly. Alternatively, the detection of non-periodic motion by the processor 14 may indicate that the detected motion may not be breathing motion. Thus, the detection of non-periodic motion by the processor 14 may be used to guard against producing a false negative result when scene variations in the camera field of view are unrelated to the subject breathing. In some cases, the processor 14 is configured to calculate the standard deviation for the time durations between adjacent peaks (e.g., that occur within a prescribed window of time/image frames), and the time durations between adjacent peaks may be considered as exhibiting an irregular pattern if the calculated standard deviation exceeds a prescribed threshold. Criteria for determining lack of periodicity, such as the prescribed standard deviation threshold described above, may be inputted via the user interface 18.

In other embodiments, the time series of the measured level of similarities is analyzed by the processor 14 in real time to determine if the patient 20 has shifted in position. FIG. 8 illustrates another example of a time series of measured level of similarities having a pattern that may be indicative of a shift in position by the patient 20. In the illustrated example, the processor 14 keeps track of the peaks 800 that represent high correlation between the image template and the input image portions. If the processor 14 determines that the peak values of the correlation for a certain prescribed time/image frames are lower than those previously, such as the example shown in FIG. 8, then the processor 14 determines that the patient 20 has shifted position. In some embodiments, if such condition is detected, the processor 14 may generate a warning signal, such as an audio and/or a visual signal, to alert that the patient 20 has shifted. Alternatively, or additionally, the processor 14 may also obtain a new image template which corresponds to the new position of the patient 20. In such cases, the method 200 of FIG. 2 will be repeated to generate new time series of correlation values using the new image template, and the time series of correlation values may be used to determine physiological information about the patient 20, as described herein. An updating of the image template allows continued breathing monitoring with high sensitivity even after the patient 20 has shifted. In some embodiments, position-shift condition may be defined as the condition where signal amplitude falls below certain percentage (e.g., 20%) of the initial signal amplitude observed after a new template is acquired. In some cases, the processor 14 is configured to compare a current peak value (e.g., peak 800d) with a previous peak value (e.g., peak 800c), and if the current peak value 800d is lower than the previous peak value 800c by more than a prescribed threshold (a value-drop threshold—“VDT”), the processor 14 then continues to monitor subsequent peak values (e.g., peaks 800e, 800f). If the subsequent peak values are consistently (e.g., within a prescribed window of time/image frames) lower than the previous peak value 800c by more than the prescribed value-drop threshold VDT, the patient 20 may be considered as having a position shift. Criteria for determining patient's position shift, such as the prescribed value-drop threshold, and the prescribed time/image frames described above, may be inputted via the user interface 18.

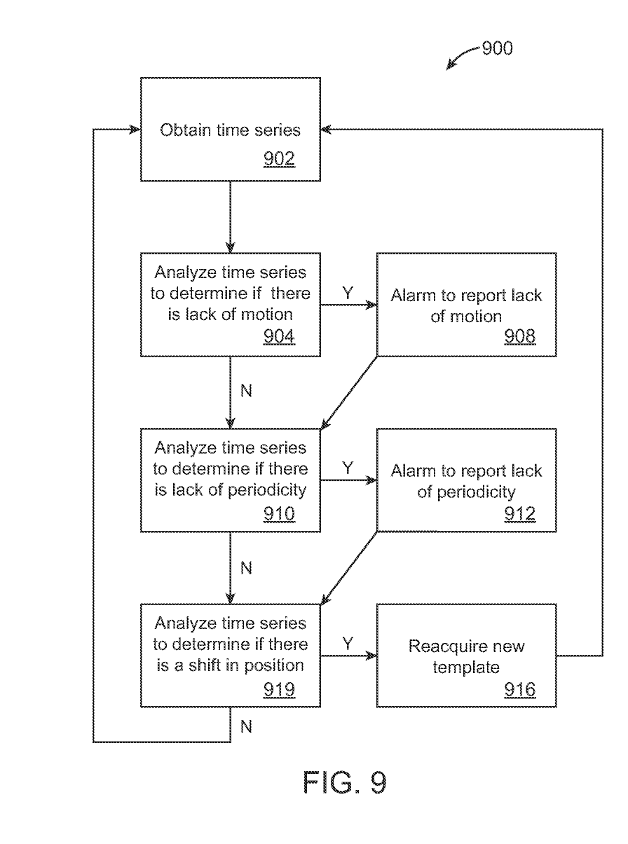

It should be noted that the time series of measured level of similarities may be used to obtain other information regarding the patient 20 in other embodiments. Also, in other embodiments, the processor 14 may be configured to determine a combination or all of the above information (e.g., lack of motion, lack of periodicity in breathing, and/or position shift) about the patient 20. FIG. 9 illustrates a method 900 for determining physiological information about the patient 20 using a time series of correlation values in accordance with some embodiments. First, a time series of correlation values is obtained (step 902). For example, the time series of correlation values may be obtained using the method 200 of FIG. 2. Next, the processor 14 analyzes the time series to determine if there is a lack of motion by the patient 20 (step 904)—e.g., using any of the techniques described herein. If the processor 14 determines that there is a lack of motion by the patient 20, the processor 14 than generates an alarm signal to report lack of motion by the patient 20 (step 908). The alarm signal may be a signal for causing a speaker to generate audio energy, or for causing a display or LCD to generate a visual warning.

The processor 14 next analyzes the time series to determine if there is a lack of periodicity in the patient's breathing (step 910)—e.g., using any of the techniques described herein. If the processor 14 determines that there is a lack of periodicity in the patient's breathing, the processor 14 then generates an alarm signal to report lack of periodicity (step 912). Alternatively, in stead of generating an alarm the processor 14 may use the detected lack of periodicity to guard against producing a false negative result for the detection of other conditions related to breathing.

Next, the processor 14 analyzes the time series to determine if the patient 20 has shifted position (step 914)—e.g., using any of the techniques described herein. If the processor 14 determines that the patient 20 has shifted position, then the processor 14 requires a new image template—e.g., using any of the techniques described herein (step 916). Alternatively, or additionally, the processor 14 may also generate an alarm signal to report position shift by the patient 20 (step 916). In any of the embodiments described herein, different sound pitch and different colors and shapes of warning signals may be used to distinguish the type of alerts (e.g., lack of motion alert, lack of periodicity alert, patient shift alert) and the severity of the alerts (e.g., the longer the duration of lack of motion, the more severe the alert).

In some embodiments, in order to maintain sensitivity, a new image template is acquired whenever one of the above conditions (no-motion, lack of periodicity, position shift) is detected. After this updating of the image template, the newly observed signal forms the basis for position-shift detection threshold also, the detection of flat-line and periodicity start anew by resetting the adaptive algorithm parameters and signal buffers.

As illustrated by the embodiments described herein, the system 10 is advantageous in that it does not require any attachment of markers that are specially designed for image detection. It also does not require the patient 20 to wear special clothing or cover, and will work as long as the optical device 12 field of view contains sufficient objects that move with the patient's breathing, such as a blanket, sheet, etc. Also, the above described techniques for determining lack of motion, lack of periodicity, and patient's position shift are advantageous because they involve simple image processing without the need to perform complex calculation to determine actual position of the patient 20 or patient's portion. The above described techniques are also advantageous in that they do not require use of complex object discrimination algorithms to identify object(s) in an image. This is because the same region of interest in each input image is compared with the template, regardless of what object is captured within the region of interest in each input frame. The embodiments of the technique described herein is also advantageous in that it is sensitive and allows pickup of smaller motion levels, such that analysis for lack of motion, periodicity, and patient shift can be performed for much smaller motion amplitudes. Because of the template re-acquisition feature, the technique is more robust because it can keep monitoring the breathing even when the patient 20 position shifts by large amounts, as long as some portion of the patient 20 that moves with breathing remains in the optical device's 12 field of view.

It should be noted that the method 900 should not be limited to the order of steps described above, and that the steps may have different orders. For example, in other embodiments, the processor 14 may perform step 910 and/or step 914 before step 904. Also, in other embodiments, two or more steps in method 900 may be performed in parallel. For example, in other embodiments, steps 904, 910, 914 may be performed in parallel by the processor 14.

In some embodiments, the processor 14 is configured to determine physiological information about the patient 20 using the time series of similarity values in real time (e.g., at substantially the same time or shortly after the current input image is obtained). Alternatively, the processor 14 may be configured to use the time series of similarity values retrospectively.

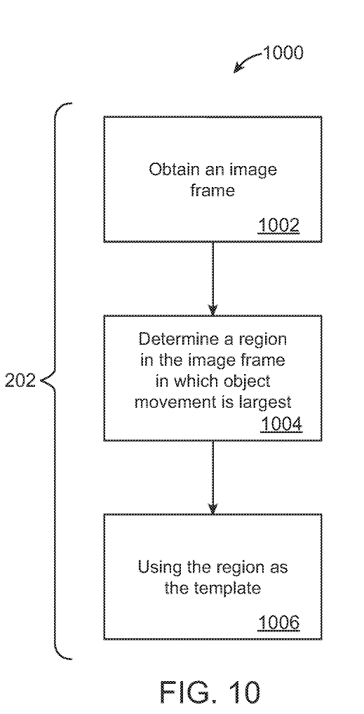

As discussed, in some embodiments, the image template in step 202 is obtained from an image within an area of an image frame in which there is patient's movement. FIG. 10 illustrates a method 1000 for determining an area in an image frame that has an image of an object captured while the object was undergoing movement in accordance with some embodiments. First, a real-time input image In is obtained using the optical device 12 (Step 1002). The image is then analyzed to determine a region in the image that captures a moving object—e.g., a region in the image where there is object movement, or where movement is the largest (Step 1004). In the illustrated embodiments, the current input image Iₙ is subtracted from a reference image RI to obtain a composite image CIₙ (i.e., CIₙ=Iₙ−RI). The reference image RI may be a previously acquired image frame such as the frame just preceding the current frame. The composite image CIₙ is then analyzed to determine an area having an image of an object that was captured while the object was moving. If there has been object movement, the pixels in the composite image CIₙ should have an increase in contrast (which represents motion energy). It may be considered that there has been object movement if the contrast increase is above a certain prescribed threshold. In other embodiments, instead of using a reference image RI, an average of previously acquired input images may be used in the above method. After the region in the image that has the largest object movement is determined, the region is then used as the template (Step 1006). In some cases, the position of the region relative to the image frame is also determined and stored for later use, as described herein. In other embodiments, other techniques for obtaining the image template in step 202 may be used, and the method 1000 needs not be performed. For example, in other embodiments, the image template in step 202 may be obtained by capturing an image frame of an object that moves with a patient movement.

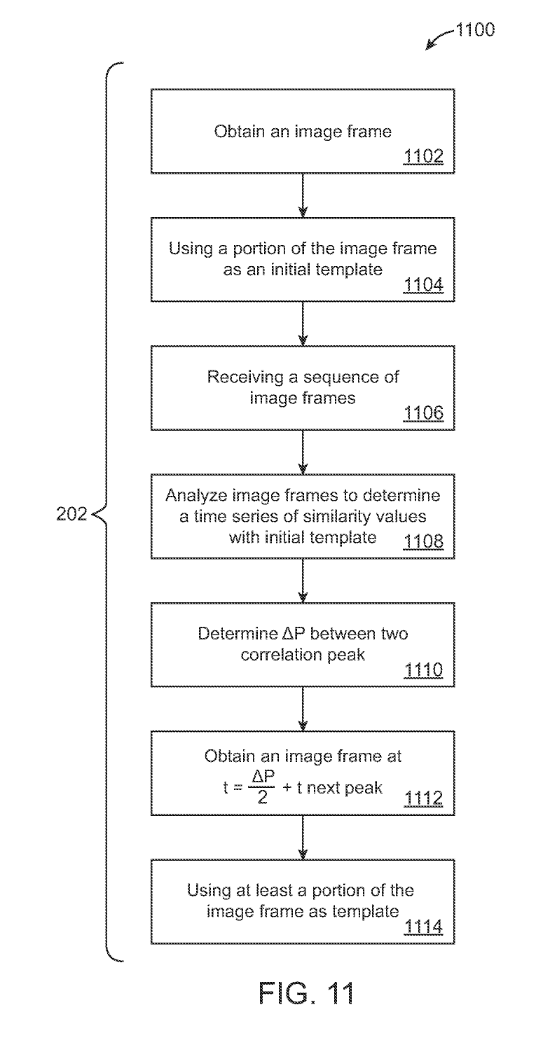

In the above embodiments, the image template is obtained when the patient 20 is at an arbitrary phase of a respiratory cycle. In other embodiments, the image template may be obtained when the patient 20 is at an end of an inhale or exhale phase. This merges the two peaks of FIG. 5 resulting in better correspondence between the similarity measure time series and the breathing state of the subject. FIG. 11 illustrates a method 1100 for obtaining the image template when the patient 20 is at an end of an inhale or exhale phase in accordance with other embodiments. First, an image frame is obtained (step 1102), and a portion of the image frame is used as an initial image template (step 1104). The image frame for the initial image template may be acquired at any time point in the breathing cycle. Next, a plurality of image frames from a sequence is received (step 1106), and the image frames are processed to determine a time series of similarity values with the initial template (step 1108). The time series of similarity values (breathing signal) resulting from this initial template has two peaks per breathing cycle if the initial template is not acquired at the exhale-end or inhale-end point of a breathing cycle—such as the example shown in FIG. 5. Next, the processor 14 performs real time analysis of the signal to detect the two consecutive peaks and the time spacing ΔP between the two peaks (step 1110). Next, an image frame is obtained at a time that is ΔP/2 after the next detected peak (step 1112), and a new image template is obtained using a portion of the image frame (step 1114). The new image template from step 1114 is then used for subsequent signal processing (e.g., for determining lack of motion by the patient 20, lack of periodicity in the patient's breathing, position shift by the patient 20, etc.). For example, the image in the area in the image frame at which there is the greatest patient's motion may be used as the image template. Alternatively, instead of a portion of the image frame, the entire image frame from step 1112 may be used as the new image template.

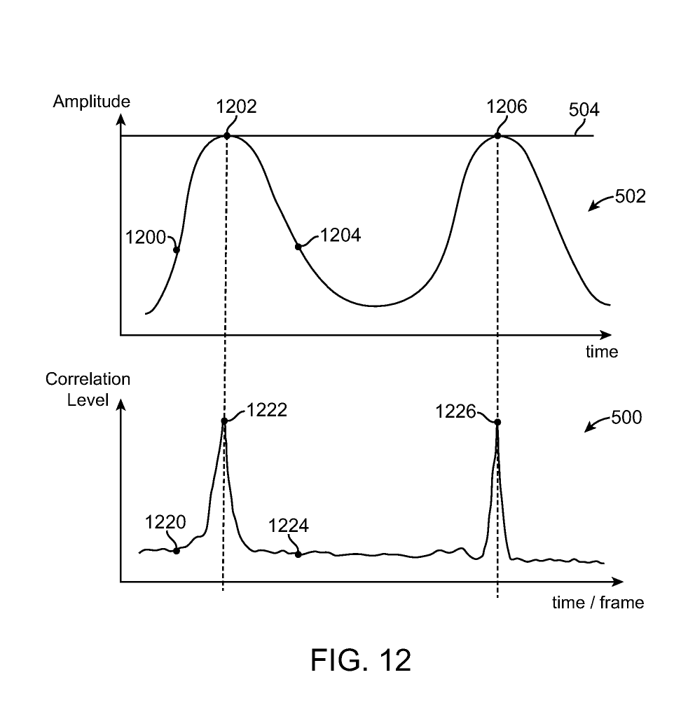

FIG. 12 illustrates another example of a time series 500 of similarity values that may be generated using the method 200 in which step 202 is achieved using the method 1100 of FIG. 11. In the figure, the time series 500 is aligned with a breathing chart 502 to show the relationship between various points in the time series 500 and the points in the breathing chart 502. The time series 500 includes a plurality of points representing levels of correlation between the image template and respective input image frames that are determined in step 206 of the method 200. The breathing chart 502 illustrates a breathing pattern of the patient 20, with the x-axis representing time, and the y-axis representing amplitudes of motion (e.g., motion of chest, motion of the patient's clothes, motion of a blanket covering the patient 20, etc.) associated with the breathing. A line 504 is shown in the chart 502, wherein the line 504 corresponds to the position of the patient 20 at an end of the inhale phase at which the image template is generated. As the patient 20 inhales at point 1200, the image frame captured by the optical device 12 will be different from the image template, and the level of similarity between the image template and the image frame corresponding to point 1200 (point 1220 in time series 500) will be low. At point 1202, the image frame captured by the optical device 12 will be the same as the image template (because they are captured when the patient 20 is in the same position—i.e., at the end of the inhale phase), and the level of similarity between the image template and the image frame corresponding to point 1202 (point 1222 in time series 500) will be high. As the patient 20 exhales, his/her position moves away from the position that corresponds to line 504, and as a result, the level of similarity between the image frame at point 1204 and the image template is relatively low (point 1224 in time series 500). The patient 20 then inhales again, and when the breathing pattern reaches point 1206, the image frame captured by the optical device 12 will be again the same as the image template (because they are captured when the patient 20 is in the same position—i.e., at the end of the inhale phase), and the level of similarity between the image template and the image frame corresponding to point 1206 (point 1226 in time series 500) will be high.

As illustrated in the figure, the peak values (e.g., points 1222,1226) in the time series 500 correlate with certain parts of a physiological motion (e.g., the end of the inhale phase). Thus, the time series 500 may be used to correlate with the physiological motion of the patient 20. Also, in the illustrated example, the processor 14 may determine the period T of the patient's breathing cycle by calculating the time spacing between adjacent peak (e.g., between peak 1222 and peak 1226). Also, as illustrated in the figure, obtaining the image template when the patient 20 is at the end of the exhale phase is advantageous in that the peaks in the time series of similarity values correspond with the respective peaks (end of inhale phase) in the breathing pattern.

In other embodiments, instead of obtaining the image template when the patient 20 is at the end of the inhale phase, the image template may be obtained when the patient 20 is at the end of the exhale phase. In such cases, the peaks in the time series of similarity values will correspond with the respective valleys (end of exhale phase) in the breathing pattern.

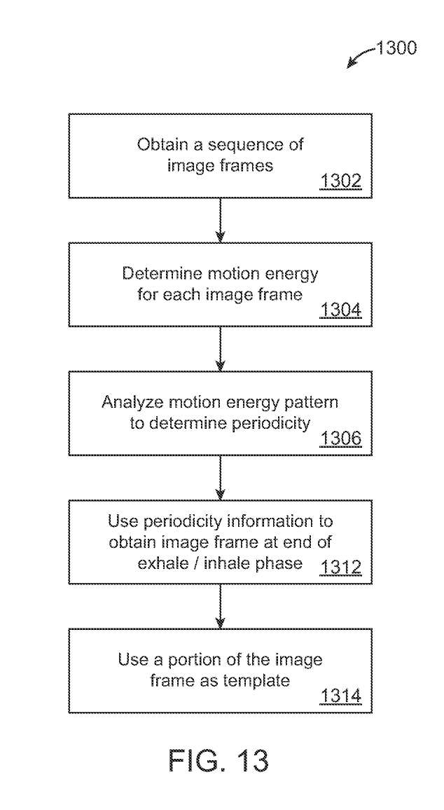

FIG. 13 illustrates another method 1300 for obtaining the image template when the patient 20 is at an end of an inhale or exhale phase in accordance with other embodiments. First, a plurality of input images is obtained using the optical device 12 (step 1302). Next, motion energy is determined for each of the input images (step 1304). In the illustrated embodiments, motion energy for each input image is determined by subtracting the current input image from a reference image, which may be, for example, a previously acquired input image. Alternatively, motion energy for each input image is determined by subtracting the current input image from an average image that is determined by taking an average of a prescribed number of previously obtained input images. The determined motion energies for respective input images are analyzed in real time as a time series to determine periodic characteristic of the patient's movement (step 1306). For example, the time series of motion energies may be used to detect time points at which the patient's motion is the least, which correspond with exhale and inhale phases of breathing but without necessarily knowing whether it is inhale or exhale. The processor then determines the time spacing ΔP between the two time points. Next, an image frame is obtained at a time that motion energy reaches a minimum indicating exhale or inhale end of breathing cycle (step 1312), and a new image template is obtained using a portion of the image frame (step 1314). The new image template from step 1312 is then used for subsequent signal processing (e.g., for determining lack of motion by the patient 20, lack of periodicity in the patient's breathing, position shift by the patient 20, etc.). For example, the image in the area in the image frame at which there is the greatest patient's motion may be used as the image template. Alternatively, instead of a portion of the image frame, the entire image frame from step 1312 may be used as the new image template.

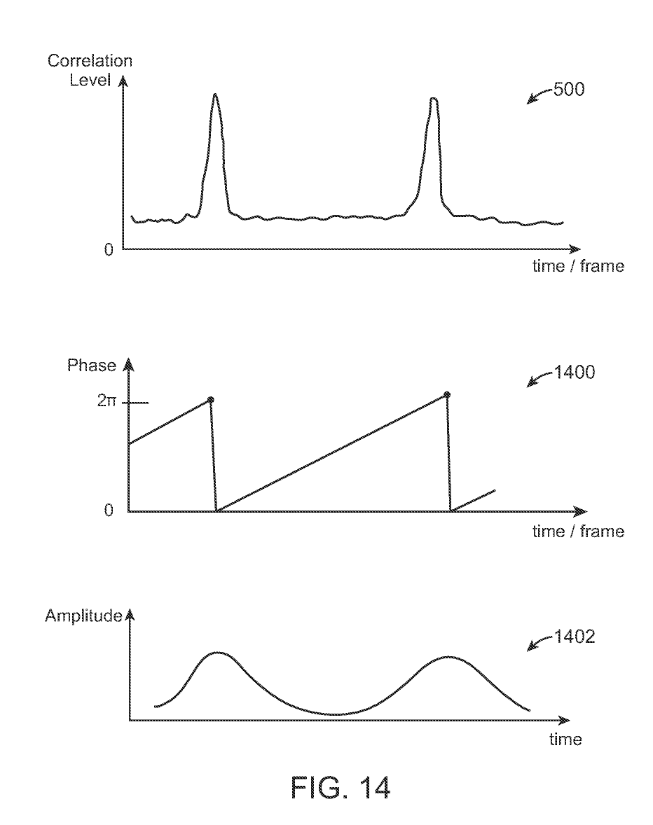

In the above embodiments, the peak values in the time series of similarity values correspond to certain positional value(s) associated with the patient's breathing. In other embodiments, the peak values in the time series of similarity values may correspond to other aspects associated with the patient's breathing. For example, in other embodiments, the peak values in the time series of similarity values may correspond to certain phase(s) of the patient's respiratory cycle. FIG. 14 illustrates an example of a time series 500 that is aligned with a phase chart 1400. The phase chart 1400 has a x-axis that represents time, and a y-axis that represents phase values, wherein each phase value represents a degree of completeness of a respiratory cycle. In the illustrated example, phase values range from 0° to 360°. In other embodiments, the phase values may have other values, and may be represented with different scales or units. The phase chart 1400 may be derived from an amplitude chart 1402, such as that shown in FIG. 5. As shown in FIG. 14, the peaks in the time series 500 correspond with certain phase value (e.g., 360°) in the phase chart 1400. In other examples, the peaks in the time series 500 may correspond with other phase values in the phase chart 1400.

It should be noted that the determined time series of similarity values should not be limited to the use described previously, and that the time series may also be used in other applications. In other embodiments, the determined time series may be used to gate a medical process, such as a diagnostic process in which a part of a patient is being imaged by an imaging machine, or a treatment process in which a part of the patient is being treated by a treatment device. For example, the peaks in the time series may be used to correspond to certain phase(s) of a respiratory cycle of a patient who is undergoing an imaging process (e.g., a CT imaging process, a PET process, a CT-PET process, a SPECT process, MRI procedure, etc.). Based on the detected peaks in the time series, the device that is used to obtain the image may be gated on or off so that images of the patient may be obtained at a desired phase of a respiratory cycle.

In other embodiments, instead of gating a generation of images, the time series of similarity values may be used to gate a collection of images retrospectively. In such cases, the time series is generated and recorded as the patient undergoes an imaging process. After a set of images are collected, the processor then analyzes the time series to bin the images such that images that are collected at a same phase of a respiratory cycle are grouped together. For example, the processor may associate all images that are generated at times at which the time series has similarity values of “0.9.” In other embodiments, the processor may be configured to bin images based on phases of a physiological cycle. For example, the processor may be configured to associate images that are generated at a same phase (e.g., 180°), or within a same phase range (e.g., 170°-190°) of a physiological cycle. [0061] Similarly, for treatment, the detected peaks of the time series of similarity values may be used to gate a beam on or off, and/or to gate an operation of a collimator (that is used to change a shape of the beam). In such cases, the beam has an energy that is sufficient for treating the patient, and may be a x-ray beam, a proton beam, or other types of particle beam. In some embodiments, after the processor detects a peak in the time series, the processor may be configured to activate or deactivate the beam, and/or to generate leaf sequencing signals to operate the leafs of the collimator, after a prescribed time that has lapsed since the detected peak.

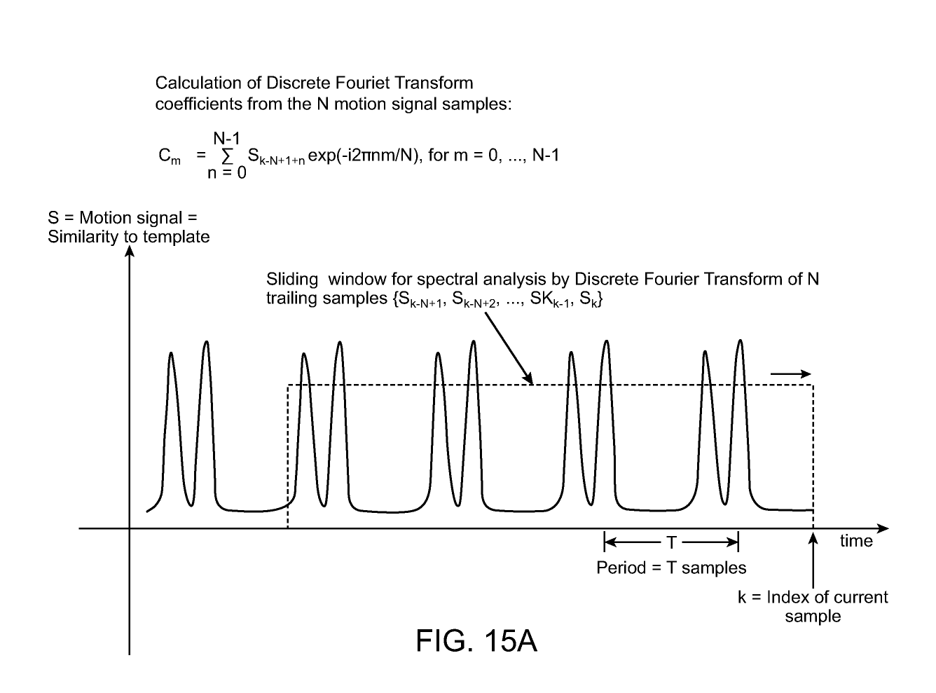

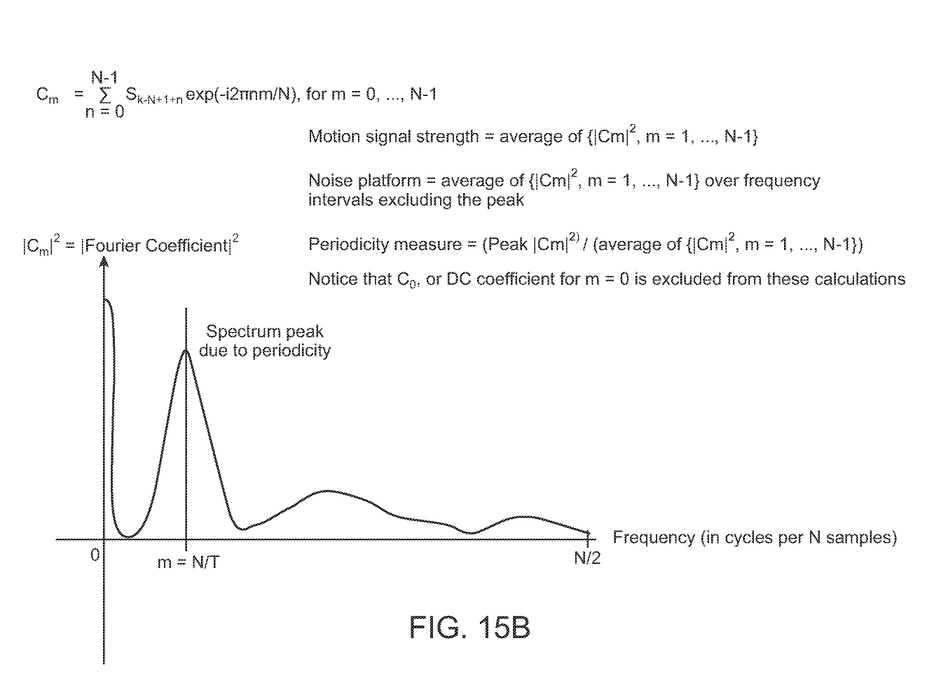

In any of the embodiments described herein, the time series of similarity values may be analyzed in the frequency domain. For example, in any of the embodiments described herein, the processor 54 may be configured to perform spectral analysis using Fourier Transform to analyze the time series of similarity values. In some cases, the processor 54 may be configured to perform spectral analysis using the time series of similarity values to detect any of the conditions described herein, such as, object motion, lack of motion, periodicity, lack of periodicity, position shift, etc. FIG. 15A illustrates an example of a time series of similarity values. As shown in the figure, when analyzing the time series in the frequency domain, a sliding window is used so that a certain amount of trailing samples S is included in the analysis. The Fourier Transform coefficients from the N motion signal samples may be calculated using the equation shown on top of FIG. 15A. FIG. 15B shows the expected power spectrum (Fourier coefficients squared) for the time series of FIG. 15A at a given time. As shown in the figure, the peak position is related to the motion period for a periodic motion. In the illustrated embodiments, a high peak-to-average ratio corresponds with a high level of periodicity, and therefore, may be used as a measure of periodicity. As shown in the figure, the average of the coefficient values (which may include the peak area) is an indication of motion amplitude irrespective of periodicity. In some embodiments, in order to establish a noise platform, the average coefficients squared outside a peak area may be calculated. As used in this specification, the term “noise platform” denotes the reference level for sensing motion from the signal. Also, the term “noise” may refer to electronic noise, which is the frame-to-frame changes of pixel values when the scene and camera are motionless. In frequency domain, if all signal spectral components (e.g., peaks in the case of periodic signals) are excluded, then the average of coefficients excluding the peak will represent the noise level. In some embodiments, instead of finding peaks and excluding them, one can look at coefficients beyond certain frequency which is known not to be anything representing physical motion, and calculate the average over those high temporal frequencies. Note that the DC component, which is the coefficient at zero frequency, is not used in the illustrated calculation because the changing component of the signal is desired to be obtained. Position shift may cause reduction in motion signal strength from its value right after acquiring a new template. The same is true if breathing motion stops. Thus, the motion signal strength may be used to detect these conditions. In some embodiments, the noise platform described above may be used to set the threshold for these measures.

Computer System Architecture

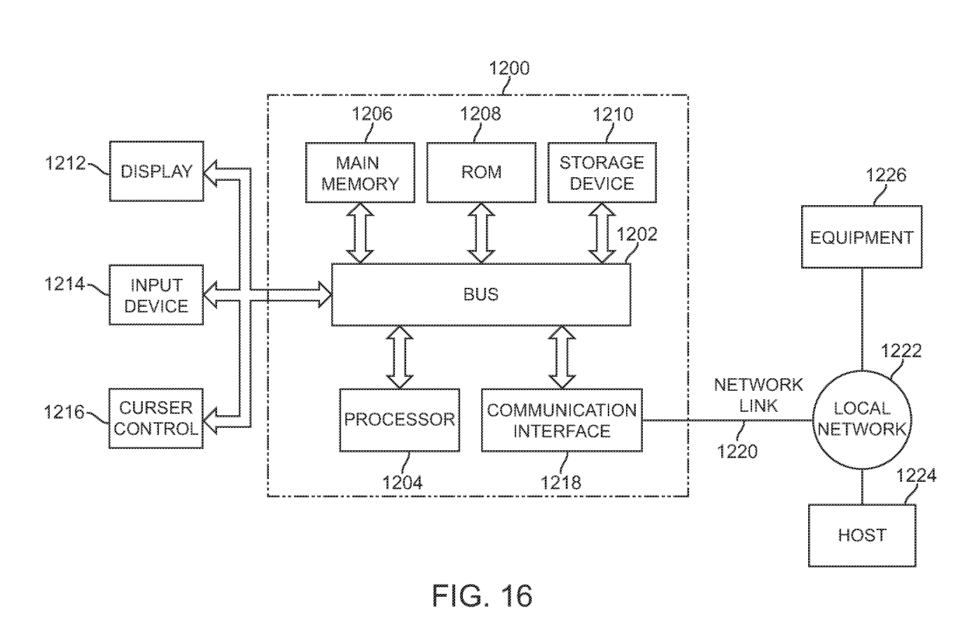

FIG. 16 is a block diagram that illustrates an embodiment of a computer system 1500 upon which an embodiment of the invention may be implemented. Computer system 1500 includes a bus 1502 or other communication mechanism for communicating information, and a processor 1504 coupled with the bus 1502 for processing information. The processor 1504 may be an example of the processor 54 of FIG. 1, or another processor that is used to perform various functions described herein. In some cases, the computer system 1500 may be used to implement the processor 54. The computer system 1500 also includes a main memory 1506, such as a random access memory (RAM) or other dynamic storage device, coupled to the bus 1502 for storing information and instructions to be executed by the processor 1504. The main memory 1506 also may be used for storing temporary variables or other intermediate information during execution of instructions to be executed by the processor 1504. The computer system 1500 further includes a read only memory (ROM) 1508 or other static storage device coupled to the bus 1502 for storing static information and instructions for the processor 1504. A data storage device 1510, such as a magnetic disk or optical disk, is provided and coupled to the bus 1502 for storing information and instructions.

The computer system 1500 may be coupled via the bus 1502 to a display 1512, such as a cathode ray tube (CRT), for displaying information to a user. An input device 1514, including alphanumeric and other keys, is coupled to the bus 1502 for communicating information and command selections to processor 1504. Another type of user input device is cursor control 1516, such as a mouse, a trackball, or cursor direction keys for communicating direction information and command selections to processor 1504 and for controlling cursor movement on display 1512. This input device typically has two degrees of freedom in two axes, a first axis (e.g., x) and a second axis (e.g., y), that allows the device to specify positions in a plane.

The computer system 1500 may be used for performing various functions (e.g., calculation) in accordance with the embodiments described herein. According to one embodiment, such use is provided by computer system 1500 in response to processor 1504 executing one or more sequences of one or more instructions contained in the main memory 1506. Such instructions may be read into the main memory 1506 from another computer-readable medium, such as storage device 1510. Execution of the sequences of instructions contained in the main memory 1506 causes the processor 1504 to perform the process steps described herein. One or more processors in a multi-processing arrangement may also be employed to execute the sequences of instructions contained in the main memory 1506. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor 1504 for execution. Such a medium may take many forms, including but not limited to, non-volatile media, volatile media, and transmission media. Non-volatile media includes, for example, optical or magnetic disks, such as the storage device 1510. Volatile media includes dynamic memory, such as the main memory 1506. Transmission media includes coaxial cables, copper wire and fiber optics, including the wires that comprise the bus 1502. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to the processor 1504 for execution. For example, the instructions may initially be carried on a magnetic disk of a remote computer. The remote computer can load the instructions into its dynamic memory and send the instructions over a telephone line using a modem. A modem local to the computer system 1500 can receive the data on the telephone line and use an infrared transmitter to convert the data to an infrared signal. An infrared detector coupled to the bus 1502 can receive the data carried in the infrared signal and place the data on the bus 1502. The bus 1502 carries the data to the main memory 1506, from which the processor 1504 retrieves and executes the instructions. The instructions received by the main memory 1506 may optionally be stored on the storage device 1510 either before or after execution by the processor 1504.

The computer system 1500 also includes a communication interface 1518 coupled to the bus 1502. The communication interface 1518 provides a two-way data communication coupling to a network link 1520 that is connected to a local network 1522. For example, the communication interface 1518 may be an integrated services digital network (ISDN) card or a modem to provide a data communication connection to a corresponding type of telephone line. As another example, the communication interface 1518 may be a local area network (LAN) card to provide a data communication connection to a compatible LAN. Wireless links may also be implemented. In any such implementation, the communication interface 1518 sends and receives electrical, electromagnetic or optical signals that carry data streams representing various types of information.

The network link 1520 typically provides data communication through one or more networks to other devices. For example, the network link 1520 may provide a connection through local network 1522 to a host computer 1524 or to equipment 1526 such as a radiation beam source or a switch operatively coupled to a radiation beam source. The data streams transported over the network link 1520 can comprise electrical, electromagnetic or optical signals. The signals through the various networks and the signals on the network link 1520 and through the communication interface 1518, which carry data to and from the computer system 1500, are exemplary forms of carrier waves transporting the information. The computer system 1500 can send messages and receive data, including program code, through the network(s), the network link 1520, and the communication interface 1518.

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. For example, the term “processor” should not be limited to a device having only one processing unit, and may include a device or system that has more than one processing units/processors. Thus, the term “processor” may refer to a single processor or a plurality of processors. Also, the term “image” should not be limited to image that is actually displayed, and may refer to image data or undisplayed image that is capable of being presented in an image form. Further, the term “patient” should not be limited to a person or animal that has a medical condition, and may refer to a healthy person or animal. In addition, any discussion herein with reference to an image of the patient or patient portion may refer an image of the patient (or patient portion) itself, the clothing that the patient is wearing, and/or the blanket that is covering the patient. Thus, an image of the patient or patient portion should not be limited to an image of the patient or patient portion itself. The specification and drawings are, accordingly, to be regarded in an illustrative rather than restrictive sense. The present inventions are intended to cover alternatives, modifications, and equivalents, which may be included within the spirit and scope of the present inventions as defined by the claims.

What is claimed:

1. A method of determining a similarity with a portion of a physiological motion, comprising:
obtaining a first image of an object;
obtaining a second image of the object;
determining a level of similarity between the first and second images; and
correlating the determined level of similarity between the first and second images with a portion of the physiological motion.

2. The method of claim 1, wherein the first and second images are obtained using a camera.

3. The method of claim 2, wherein the camera has an auto-focus feature.

4. The method of claim 1, wherein the first and second images are obtained using a radiation machine.

5. The method of claim 1, wherein the first image is a subset of a first image frame.

6. The method of claim 5, wherein the second image is a subset of a second image frame, and wherein a position of the first image in the first image frame is the same as a position of the second image in the second image frame.

7. The method of claim 5, further comprising obtaining the first image frame, wherein the first image is obtained by:
determining a portion in the first image frame, wherein the portion of the first image frame contains an image of a portion of the object that was undergoing a relatively high motion when the first image frame was obtained; and
using the portion as the first image.

8. The method of claim 5, further comprising obtaining the first image frame, wherein the first image frame is obtained when the object is at an end of an exhale motion.

9. The method of claim 5, further comprising obtaining the first image frame, wherein the first image frame is obtained when the object is at an end of an inhale motion.

10. The method of claim 5, further comprising:
determining a first time point t₁ at which a level of correlation between a reference image and a first input image is highest;
determining a second time point t₂ at which a level of correlation between a reference image and a second input image is highest; and
determining a period T that is between the first and second time points;
wherein the first image is obtained at a time that is T/2 after a detected peak.

11. The method of claim 10, wherein the reference image is obtained before the first input image, the first input image is obtained before the second input image, the second input image is obtained before the first image, and the first image is obtained before the second image.

12. The method of claim 11, wherein the reference image, the first input image, the second input image, the first image, and the second image are obtained using a same imaging device.

13. The method of claim 1, further comprising obtaining a new image for use as the first image when the level of determined correlation is below a prescribed threshold.

14. The method of claim 1, further comprising:
obtaining a third image of the object;
determining a level of correlation between the first and third images; and
correlating the determined level of correlation between the first and third images with another portion of the physiological motion.

15. The method of claim 1, wherein the physiological motion comprises a respiratory motion.

16. The method of claim 1, wherein the physiological motion comprises a cardiac motion.

17. The method of claim 1, wherein the object comprises at least a portion of a blanket.

18. The method of claim 1, wherein the object comprises at least a portion of a person's clothes or a person's skin.

19. The method of claim 1, wherein the portion of the physiological motion comprises an amplitude of the motion at a time point.

20. The method of claim 1, wherein the portion of the physiological motion comprises a phase of the motion at a time point.

21. The method of claim 1, wherein the level of correlation represents how far the object is away from a reference location.

22. The method of claim 21, wherein the reference location comprises a location of the object as captured in the first image.

23. The method of claim 1, wherein the act of determining a level of correlation between the first and second images does not require a detection of a marker in the second image.

24. The method of claim 1, wherein the object is a patient, and wherein the patient does not have a marker that is specifically designed to be detected by an imaging device.

25. The method of claim 1, further comprising performing a spectral analysis using the determined level of similarity.

26. The method of claim 25, wherein the spectral analysis is performed to detect position shift, lack of periodicity, or lack of motion.

27. A computer product having a set of instructions, an execution of which causes a method of determining a similarity with a portion of a physiological motion to be performed, the method comprising:
obtaining a first image of an object;
obtaining a second image of the object;
determining a level of similarity between the first and second images; and
correlating the determined level of similarity between the first and second images with a portion of the physiological motion.

28. The computer product of claim 27, wherein the first and second images are obtained using a camera.

29. The computer product of claim 28, wherein the camera has an auto-focus feature.

30. The computer product of claim 27, wherein the first and second images are obtained using a radiation machine.

31. The computer product of claim 27, wherein the first image is a subset of a first image frame.

32. The computer product of claim 31, wherein the second image is a subset of a second image frame, and wherein a position of the first image in the first image frame is the same as a position of the second image in the second image frame.

33. The computer product of claim 31, the method further comprising obtaining the first image frame, wherein the first image is obtained by:
determining a portion in the first image frame, wherein the portion of the first image frame contains an image of a portion of the object that was undergoing a relatively high motion when the first image frame was obtained; and
using the portion as the first image.

34. The computer product of claim 31, the method further comprising obtaining the first image frame, wherein the first image frame is obtained when the object is at an end of an exhale motion.

35. The computer product of claim 31, the method further comprising obtaining the first image frame, wherein the first image frame is obtained when the object is at an end of an inhale motion.

36. The computer product of claim 31, the method further comprising:
determining a first time point t₁ at which a level of correlation between a reference image and a first input image is highest;
determining a second time point t₂ at which a level of correlation between a reference image and a second input image is highest; and
determining a period T that is between the first and second time points;
wherein the first image is obtained at a time that is T/2 after a detected peak.

37. The computer product of claim 36, wherein the reference image is obtained before the first input image, the first input image is obtained before the second input image, the second input image is obtained before the first image, and the first image is obtained before the second image.

38. The computer product of claim 37, wherein the reference image, the first input image, the second input image, the first image, and the second image are obtained using a same imaging device.

39. The computer product of claim 27, the method further comprising obtaining a new image for use as the first image when the level of determined correlation is below a prescribed threshold.

40. The computer product of claim 27, the method further comprising:
obtaining a third image of the object;
determining a level of correlation between the first and third images; and
correlating the determined level of correlation between the first and third images with another portion of the physiological motion.

41. The computer product of claim 27, wherein the physiological motion comprises a respiratory motion.

42. The computer product of claim 27, wherein the physiological motion comprises a cardiac motion.

43. The computer product of claim 27, wherein the object comprises at least a portion of a blanket.

44. The computer product of claim 27, wherein the object comprises at least a portion of a person's clothes.

45. The computer product of claim 27, wherein the portion of the physiological motion comprises an amplitude of the motion at a time point.

46. The computer product of claim 27, wherein the portion of the physiological motion comprises a phase of the motion at a time point.

47. The computer product of claim 27, wherein the level of correlation represents how far the object is away from a reference location.

48. The computer product of claim 47, wherein the reference location comprises a location of the object as captured in the first image.

49. The computer product of claim 27, wherein the act of determining a level of correlation between the first and second images does not require a detection of a marker in the second image.

50. The computer product of claim 27, wherein the object is a patient, and wherein the patient does not have a marker that is specifically designed to be detected by an imaging device.

51. The computer product of claim 27, wherein the process further comprises performing a spectral analysis using the determined level of similarity.

52. The computer product of claim 51, wherein the spectral analysis is performed to detect position shift, lack of periodicity, or lack of motion.

53. A system for determining a similarity with a portion of a physiological motion, comprising:
means for obtaining a first image of an object and a second image of the object;
means for determining a level of similarity between the first and second images; and
means for correlating the determined level of similarity between the first and second images with a portion of the physiological motion.
